(19) United States
(12) Patent Application Publication
(10) Pub. No.: US 2023/0412527 A1
(43) Pub. Date: Dec. 21, 2023

(54) Network Card and Packet Processing Method

(71) Applicant: NIPPON TELEGRAPH AND TELEPHONE CORPORATION, Tokyo (JP)

(72) Inventors: Yuki Arikawa, Tokyo (JP); Kenji Tanaka, Tokyo (JP); Tsuyoshi Ito, Tokyo (JP); Tsutomu Takeya, Tokyo (JP); Takeshi Sakamoto, Tokyo (JP)

(21) Appl. No.: 18/251,666

(22) PCT Filed: Nov. 13, 2020
(86) PCT No.: PCT/JP2020/042455

§ 371 Date: May 3, 2023

(51) Int. Cl. H04L 49/9047; H04L 49/90

(52) U.S. Cl. CPC H04L 49/9047; H04L 49/9068

(57) ABSTRACT

In a network interface card, a buffer is provided with a plurality of queues corresponding to packet priority levels, a packet processing circuit stores a packet in a queue in the buffer corresponding to the priority level obtained from a packet received by a physical port, and a control circuit sequentially selects a queue in the buffer on the basis of the packet priority level and allocates a packet read from the selected queue to a computation/processing circuit.

### CROSS-REFERENCE TO RELATED APPLICATIONS

This patent application is a national phase filing under section 371 of PCT application no. PCT/JP2020/042455, filed on Nov. 13, 2020, which application is incorporated herein by reference in its entirety.

### TECHNICAL FIELD

The present invention relates to a packet processing technology for executing computation/processing on a packet at the time of transfer control of the packet based on priority control in a communication network.

### BACKGROUND

Technological innovation has progressed in many fields such as machine learning, artificial intelligence (AI), and the Internet of Things (IoT), and sophistication of services and provision of added values thereto are being actively performed with the use of various types of information and data. In such processing, it is necessary to perform a large amount of calculation, and an information processing infrastructure therefor is essential.

For example, Non Patent Literature 1 points out that although attempts to update an existing information processing infrastructure have been developed, it is also a fact that modern computers have not been able to cope with rapidly increasing data, and in order to achieve further evolution in the future, a “post-Moore technology” beyond Moore's Law needs to be established.

As the post-Moore technology, for example, Non Patent Literature 2 discloses a technology called flow-centric computing. In flow-centric computing, a new concept of moving data to a place where a calculation function exists and performing processing has been introduced, instead of the conventional idea of computing in which processing is performed at a place where data exists.

In order to realize such flow-centric computing, not only is a broadband communication network necessary for data movement required, but also data movement may not be able to be efficiently performed unless the communication network is efficiently controlled at the same time.

### CITATION LIST

### Patent Literature

Patent Literature 1: JP 2020-72346 A

### Non Patent Literature

Non Patent Literature 1: “NTT Technology Report for Smart World 2020”, Nippon Telegraph and Telephone Corporation, 28 May 2020, [searched on 19 Oct. 2020], Internet, <https://www.rd.ntt/_assets/pdf/techreport/NTI_TRFSW_2020_EN_W.pdf>
Non Patent Literature 2: R. Takano and T. Kudoh, “Flow-centric computing leveraged by photonic circuit switching for the post-moore era”, Tenth IEEE/ACM International Symposium on Networks-on-Chip (NOCS), Nara, 2016, pp. 1-3, [Retrieved on 19 Oct. 2020], Internet <https://ieeexplore.ieee.org/abstract/document/7579339>

### SUMMARY

### Technical Problem

In general, flow control is known as a technology used for increasing the speed and efficiency of data movement in a communication network (e.g., Patent Literature 1). According to such a conventional technology, it is possible to suppress packet loss by dynamically controlling a communication path in accordance with a load on a communication network and the accumulation capacity of a buffer.

On the other hand, in flow-centric computing via a communication network, processing details and a priority level are different with each piece of data. For this reason, in addition to priority control in a communication network, it is necessary to allocate computation/processing on data in consideration of the processing details and the priority level of each piece of data. The conventional technology therefore does not disclose a packet processing technology for combining priority control in a communication network and allocation control of computation/processing on packets.

Embodiments of the present invention are intended to solve such a problem, and various embodiments are aimed at providing a packet processing technology capable of combining priority control in a communication network and allocation control of computation/processing on packets.

### Solution to Problem

An embodiment of the present invention provides a network interface card including: a plurality of physical ports configured to receive and transmit packets via transmission paths; a buffer configured to temporarily accumulate packets; a packet processing circuit configured to store, in the buffer, primary packets received by the plurality of physical ports; a plurality of computation/processing circuits configured to perform predetermined computation/processing on secondary packets read from the buffer; and a control circuit configured to control reading from the buffer and allocation of the secondary packets to the computation/processing circuits, in which the buffer includes a plurality of queues corresponding to priority levels of the packets, the packet processing circuit stores the primary packets in a queue in the buffer corresponding to the priority level obtained from the primary packets, and the control circuit sequentially selects a queue in the buffer on the basis of the packet priority level, and allocates the secondary packets read from the selected queue to the plurality of computation/processing circuits.

Furthermore, an embodiment of the present invention provides a packet processing method used in a network interface card including: a plurality of physical ports configured to receive and transmit packets via transmission paths; a buffer configured to temporarily accumulate packets; a packet processing circuit configured to store, in the buffer, primary packets received by the plurality of physical ports; a plurality of computation/processing circuits configured to perform predetermined computation/processing on secondary packets read from the buffer; and a control circuit configured to control reading from the buffer and allocation of the secondary packets to the computation/processing circuits, the packet processing method including: a first step of storing, by the packet processing circuit, the primary packets in a queue in the buffer corresponding to the priority level obtained from the primary packets; and a second step of sequentially selecting, by the control circuit, a queue in the buffer on the basis of the packet priority level, and allocating the secondary packets read from the selected queue to the plurality of computation/processing circuits.

### Advantageous Effects of Embodiments of the Invention

According to embodiments of the present invention, priority control in a communication network and allocation control of computation/processing on packets can be combined, and as a result, the computation/processing can be efficiently executed on the packets.

### BRIEF DESCRIPTION OF THE DRAWINGS

FIG. 1 is a block diagram illustrating a configuration of a network interface card according to a first embodiment.

FIG. 2 is a block diagram illustrating a configuration of a buffer according to the first embodiment.

FIG. 3 is a flowchart illustrating a packet processing method of the network interface card according to the first embodiment.

FIG. 4 is a flowchart illustrating control circuit packet control processing according to the first embodiment.

FIG. 5 is a block diagram illustrating a configuration of a buffer according to a second embodiment.

FIG. 6 is a flowchart illustrating packet control processing of a control circuit according to the second embodiment.

FIG. 7 is a flowchart illustrating another series of packet control processing of the control circuit according to the second embodiment.

FIG. 8 is a block diagram illustrating a configuration of a buffer according to a third embodiment.

FIG. 9 is a flowchart illustrating packet control processing of a control circuit according to the third embodiment.

FIG. 10 is a block diagram illustrating a configuration of a buffer according to a fourth embodiment.

FIG. 11 is a flowchart illustrating packet control processing of a control circuit according to the fourth embodiment.

FIG. 12 is a block diagram illustrating a configuration of a buffer according to a fifth embodiment.

FIG. 13 is a flowchart illustrating packet control processing of a control circuit according to the fifth embodiment.

FIG. 14 is a block diagram illustrating a configuration of a buffer according to a sixth embodiment.

FIG. 15 is a block diagram illustrating a configuration of a buffer according to a seventh embodiment.

FIG. 16 is a block diagram illustrating a configuration of a buffer according to an eighth embodiment.

FIG. 17 is a block diagram illustrating a configuration of a buffer according to a ninth embodiment.

FIG. 18 is a block diagram illustrating a configuration of a buffer according to a tenth embodiment.

FIG. 19 is a block diagram illustrating a configuration of a buffer according to an eleventh embodiment.

FIG. 20 is a block diagram illustrating a configuration of a conventional network interface card.

### DETAILED DESCRIPTION OF ILLUSTRATIVE EMBODIMENTS

Next, embodiments of the present invention will be described with reference to the drawings.

### First Embodiment

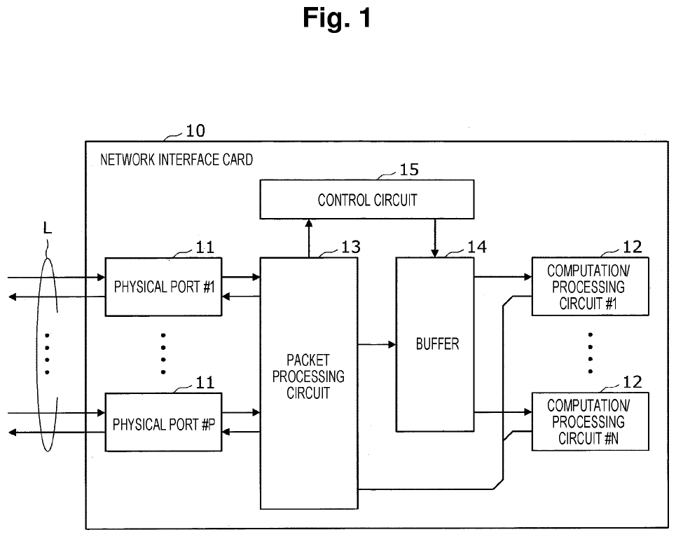

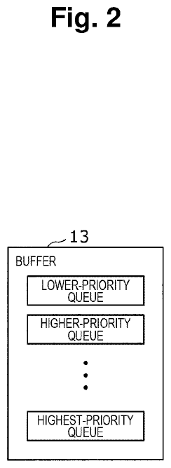

First, a network interface card 10 according to a first embodiment of the present invention will be described with reference to FIGS. 1 and 2. FIG. 1 is a block diagram illustrating a configuration of the network interface card according to the first embodiment. FIG. 2 is a block diagram illustrating a configuration of a buffer according to the first embodiment.

### Network Interface Card

The network interface card (NIC) is also called a network adapter and is an extension device for connecting equipment such as a computer to a transmission path. The network interface card 10 is available in, but is not limited to, a card type used in a form of being inserted into an expansion slot prepared in a rear surface or a side surface of a housing of equipment or inside the housing. Other examples include a form of being mounted as a circuit in a housing of equipment, for example, on a substrate equipped with a control circuit 15 such as a CPU, and a form of being connected to an interface for peripheral equipment such as a universal serial bus (USB) port.

As illustrated in FIG. 1, the network interface card 10 according to the present embodiment includes P (P is an integer of 2 or more) physical ports (#1 to #P) 11, N (N is an integer of 2 or more) computation/processing circuits 12 (#1 to #N), a packet processing circuit 13, a buffer 14, and the control circuit 15 as main circuit units.

As a whole, the network interface card 10 is configured such that packets (primary packets) such as data packets received by the physical ports 11 via transmission paths L are temporarily stored in the buffer 14 via the packet processing circuit 13, the computation/processing circuits 12 execute predetermined computation/processing on packets (secondary packets) sequentially read from the buffer 14, obtained computation/processing results are stored in the packets, and the packets are transmitted from the physical ports 11.

At this time, the packet processing circuit 13 extracts header information of each packet, and the control circuit 15 reads packets from the buffer 14 and outputs the packets to the computation/processing circuits 12 in an order based on a priority level or a combination of the priority level and a packet classification included in the header information.

### Physical Port

The physical ports 11 (#1 to #P) are input/output interfaces with external devices, external networks, and external connection devices (all not illustrated), and have a function of receiving packets by optical or electrical signals input from the outside via the transmission paths L, and a function of outputting, via the transmission paths L by optical or electrical signals, packets for transmitting computation/processing results obtained by the network interface card 10 to the outside. Specifically, the physical ports 11 are constituted by optional input/output interfaces such as Ethernet (registered trademark) ports, InfiniBand ports, or I/O serial interfaces such as PCI Express, or may be constituted not only by input/output interfaces obtained by general commercially available technologies but also by uniquely defined interfaces.

### Computation/Processing Circuit

The computation/processing circuits 12 (#1 to #N) have a function of performing predetermined computation/processing (computation or processing) on data included in packets read from the buffer 14 and a function of outputting obtained computation/processing results (computation results or processing results). Output from the computation/processing circuits 12 is stored in packets in the packet processing circuit 13, and then output from the physical ports 11 to the above-described external devices, external networks, and external connection devices via the transmission paths L.

The computation/processing circuits 12 may be realized by software that runs on a central processing unit (CPU) or a graphics processing unit (GPU), or may be realized by hardware such as a large scale integration (LSI) circuit formed in a field programmable gate array (FPGA) or an application specific integrated circuit (ASIC). Furthermore, the computation/processing circuit 12 may be implemented on the same physical device as any or all of the physical ports 11, the packet processing circuit 13, the buffer 14, and the control circuit 15. Furthermore, each of the computation/processing circuits 12 may be constituted by a device of a different type or a dedicated circuit that provides a function of a different type, or may be constituted by the same processor so as to be able to be used for general purposes like a general-purpose processor.

### Packet Processing Circuit

The packet processing circuit 13 has a function of performing predetermined communication protocol processing on packets input from the physical ports 11, a function of extracting header information stored in packet headers of the packets, a function of notifying the control circuit 15 of the extracted header information, and a function of storing the packets in the buffer 14. The communication protocol processing is constituted by general protocol processing such as TCP/IP, and is equivalent to that provided by a commercially available network interface card.

The header information the control circuit 15 is notified of includes packet classifications used at the time of control of computation/processing to be executed on a packet, in addition to a packet priority level (e.g., highest priority, priority, or best effort) based on priority control in a communication network.

Among the packet classifications to which the packet belongs, a classification regarding a packet user and a classification regarding the computation/processing circuit 12 that is to perform the computation/processing on the packet are specified on the basis of information included in the header information, such as a user ID or a VLAN ID for identifying the packet user, a number for identifying the service to be applied to the packet, and information regarding the computation/processing details to be executed on the packet.

The packet processing circuit 13 may notify the control circuit 15 of port information indicating from which of the physical ports 11 the packet has been input, the port information being included in the header information. Among the packet classifications, a classification regarding the physical port 11 that has received the packet is specified on the basis of this port information.

The packet processing circuit 13 also has a function of analyzing packets input from the physical ports 11 and storing the packets in the corresponding queues in the buffer 14, on the basis of the packet priority levels described above or a predetermined sorting rule using the packet priority levels and the packet classifications. For example, in a case where the buffer 14 is provided with a queue for each priority level, a packet is stored in the queue of the corresponding priority level on the basis of information regarding the packet priority level (e.g., highest priority, priority, or best effort) in the header information.

### Buffer

The buffer 14 is provided with a plurality of queues for storing packets and has a function of temporarily storing a packet input from the packet processing circuit 13 and a function of outputting a packet from a designated queue on the basis of a read instruction from the control circuit 15. The control circuit 15 reads a packet from an optional queue in the buffer 14 and outputs the packet to the computation/processing circuit 12. For example, as illustrated in FIG. 2, providing a plurality of queues, one for each packet priority level, in the buffer 14 allows for priority control such as outputting packets to the computation/processing circuits 12 in preferential order from the highest-priority queue.

### Control Circuit

The control circuit 15 has a function of specifying a priority level related to a packet accumulated in the buffer 14 and available choices (options) for the packet classification on the basis of header information of which the packet processing circuit 13 has notified, a function of selecting a queue corresponding to the priority level or a combination of the priority level and the packet classification, reading a packet from the selected queue, and outputting the packet to any of the computation/processing circuits 12, a function of measuring times elapsed from the start of accumulation related to the packets accumulated in the selected queue, that is, accumulation times, and a function of selecting a packet to be read from the queue on the basis of the accumulation times.

Specifically, the control circuit 15 determines whether an excess packet, which has an accumulation time that exceeds a preset threshold, is accumulated in the buffer 14, and in a case where there is an excess packet, the excess packet is read and output to the computation/processing circuit 12. In a case where no excess packet is accumulated, the control circuit 15 selects a queue from which a packet is to be read from the buffer 14.

For example, in a case where the buffer 14 is provided with a queue for each priority level, the control circuit 15 selects a read queue, in order from the highest-priority queue to a lower-priority queue. In a case where no packet is accumulated in the selected queue, the control circuit 15 changes the read queue. For example, the control circuit 15 first selects the highest-priority queue, and if no packet is accumulated in the highest-priority queue, sequentially selects a queue with the next highest priority, and selects, as a read queue, a queue in which a packet is accumulated.

In a case where there is a packet accumulated in the selected queue, the control circuit 15 determines whether there is a computation/processing circuit 12 to which the packet can be allocated. In a case where none of the computation/processing circuits 12 allows for allocation, the control circuit 15 continues to accumulate the packet in the buffer 14 until the next allocation timing. This applies to, for example, a case where the computation/processing circuit 12 capable of processing the packet is being used for processing another packet. In a case where there is a computation/processing circuit 12 to which the packet can be allocated, the control circuit 15 reads the packet from the buffer 14 and inputs the packet to the computation/processing circuit 12.

The control circuit 15 may grasp processing details to be executed by the computation/processing circuit 12 for the packet on the basis of the header information of the packet. In a case where a plurality of computation/processing circuits 12 that implement different functions is provided, a computation/processing circuit 12 capable of processing the packet at high speed or low power, that is, the computation/processing circuit 12 suitable for the details of the computation/processing, may be selected from the plurality of computation/processing circuits 12. For example, for processing with a relatively small amount of computation, a computation/processing circuit 12 such as a CPU or a general-purpose processor is selected. On the other hand, for processing with a relatively large amount of computation, such as detecting a person from a moving image, a computation/processing circuit 12 equipped with a GPU or hardware specialized for that processing is selected.

The above description shows an example in which accumulation times of packets in a queue of the buffer 14 are measured and an excess packet, which exceeds the threshold, is preferentially allocated to a computation/processing circuit 12, and the threshold serving as a trigger for allocation in the control may be dynamically changed or a fixed value may be used. For example, in a case where the amount of data traffic is small, the threshold can be set to be shorter so that packets stored in a lower-priority queue can be relatively more likely to be allocated.

The above description shows an example in which the control circuit 15 determines whether to allocate processing of the packet on the basis of whether there is a free computation/processing circuit 12, but the determination on whether to allocate is not limited thereto. For example, in a case where the computation/processing circuits 12 vary in processing performance, a computation/processing circuit 12 suitable for the processing of the packet may be selected. Furthermore, in a case where a computation/processing circuit 12 having the best processing performance for the processing of the packet among a plurality of computation/processing circuits 12 is not free, a computation/processing circuit 12 having the next best processing performance may be allocated.

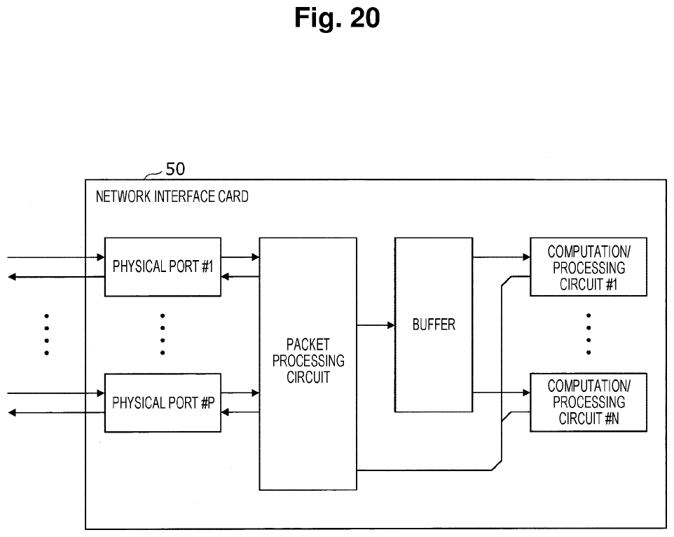

FIG. 20 is a block diagram illustrating a configuration of a conventional network interface card. A conventional network interface card 50 has a function of performing only a part of computation/processing as illustrated in FIG. 20, whereas the network interface card 10 according to the present embodiment is different in that the buffer 14 is provided with a plurality of queues, and the control circuit 15 controls allocation of packets to the computation/processing circuits 12 for each queue. This allows for, for example, preferential execution of computation/processing on a higher-priority packet. It is therefore possible to shorten a packet processing time and to level the load on the entire system by processing lower-priority packets during periods of light load on the computation/processing circuits 12.

### Operation of First Embodiment

Next, an operation of the network interface card 10 according to the first embodiment will be described. Hereinafter, a packet computation operation indicating the operation of the entire network interface card 10 and a packet control operation of the control circuit 15 will be described.

### Packet Computation Operation

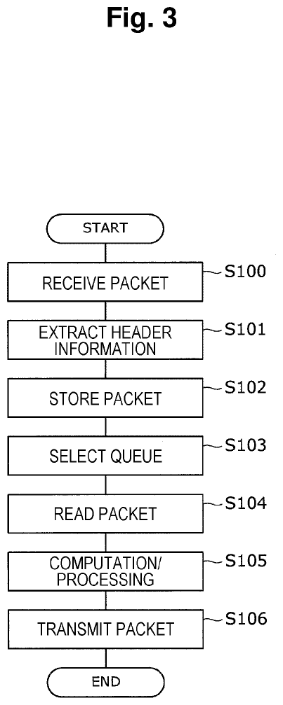

First, a packet computation operation of the network interface card 10 according to the first embodiment will be described with reference to FIG. 3. FIG. 3 is a flowchart illustrating a packet processing method of the network interface card according to the first embodiment.

As illustrated in FIG. 3, first, the physical port 11 receives a packet from an external device, an external network, or an external connection device via a transmission path L (step S100).

Subsequently, the packet processing circuit 13 executes predetermined communication protocol processing on the packet input from the physical port 11, extracts header information of the packet, and notifies the control circuit 15 of the extracted header information (step S101). Furthermore, the packet processing circuit 13 stores the packet in the buffer 14 (step S102) (first step).

Next, the control circuit 15 selects a queue from which a packet is to be read from the buffer 14 on the basis of the header information of which the packet processing circuit 13 has notified (step S103), reads a packet from the selected queue, and outputs the packet to a computation/processing circuit 12 (step S104) (second step). At this time, the buffer 14 reads a packet from the designated queue on the basis of a read instruction from the control circuit 15 and outputs the packet to the computation/processing circuit 12. For example, providing a plurality of queues, one for each packet priority level, allows for priority control using the function such as reading and outputting packets in preferential order from the highest-priority queue.

The computation/processing circuit 12 executes predetermined computation/processing on the packet input from the buffer 14 and outputs an obtained computation/processing result to the packet processing circuit 13 (step S105).

The packet processing circuit 13 stores, in a packet, the computation/processing result output from the computation/processing circuit 12, transmits the packet as an optical or electrical signal from the physical port 11 (step S106), and ends a series of packet computation/processing.

### Packet Control Operation

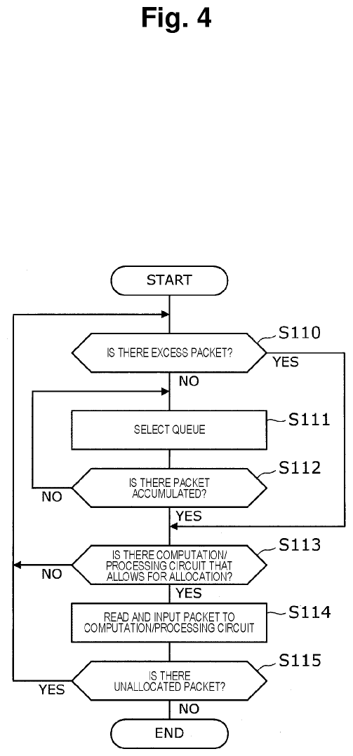

Next, the packet control operation of the control circuit 15 in steps S103 and S104 in FIG. 3 will be described with reference to FIG. 4. FIG. 4 is a flowchart illustrating packet control processing of the control circuit according to the first embodiment.

As illustrated in FIG. 4, first, the control circuit 15 checks whether there is an excess packet, which has an accumulation time that exceeds the threshold, among the packets accumulated in the queues of the buffer 14 (step S110). In a case where there is an excess packet (step S110: YES), the processing proceeds to step S113 described later.

In a case where there is no excess packet (step S110: NO), the control circuit 15 selects, from the queues in the buffer 14, a queue from which a packet is to be read (step S111). For example, in a case where a queue is provided for each priority level, the queues are selected in order from the highest-priority queue to a lower-priority queue.

Next, the control circuit 15 checks whether there is a packet accumulated in the selected queue (step S112). In a case where there is no packet accumulated in the selected queue (step S112: NO), the processing returns to step S111 to change the queue to be selected as a read queue. For example, in a case of selection in order from the highest-priority queue to a lower-priority queue, if no packet is accumulated in the highest-priority queue, a queue with the next highest priority (higher-priority queue) is selected as a read queue. In a case where there is a packet accumulated in the selected read queue (step S112: YES), the processing proceeds to step S113 described later.

In step S113, the control circuit 15 checks whether there is a computation/processing circuit 12 to which the packet to be read from the read queue can be allocated (step S113).

In a case where none of the computation/processing circuits 12 allows for allocation (step S113: NO), the control circuit 15 continues to accumulate the packet in the buffer 14 until the next allocation timing, and the processing returns to step S110. This applies to, for example, a case where the computation/processing circuit 12 capable of processing the packet is being used for processing another packet.

On the other hand, in a case where there is a computation/processing circuit 12 to which the packet can be allocated (step S113: YES), the packet is read from the selected read queue of the buffer 14 and input to the computation/processing circuit 12 (step S114).

Note that the control circuit 15 may grasp processing details to be executed by the computation/processing circuit 12 for the packet on the basis of the header information of the packet. In a case where a plurality of computation/processing circuits 12 that implement different functions is provided, a computation/processing circuit 12 capable of processing the packet at high speed or low power, that is, the computation/processing circuit 12 suitable for the details of the computation/processing, may be selected from the plurality of computation/processing circuits 12. For example, for processing with a relatively small amount of computation, a computation/processing circuit 12 such as a CPU or a general-purpose processor is selected. On the other hand, for processing with a relatively large amount of computation, such as detecting a person from a moving image, a computation/processing circuit 12 equipped with a GPU or hardware specialized for that processing is selected.

Thereafter, the control circuit 15 checks whether there is an unallocated packet in the buffer 14, such as a packet that can be allocated to another computation/processing circuit 12 (step S115). In a case where there is an unallocated packet (step S115: YES), the processing returns to step S110, and similar processing is repeated. In a case where there is no unallocated packet (step S115: NO), the series of packet control processing ends.

### Effects of First Embodiment

As described above, the network interface card 10 of the present embodiment has a configuration in which the buffer 14 is provided with a plurality of queues corresponding to packet priority levels, the packet processing circuit 13 stores a packet in a queue in the buffer 14 corresponding to the priority level obtained from a packet received by a physical port 11, and the control circuit 15 sequentially selects a queue in the buffer 14 on the basis of the packet priority level and allocates a packet read from the selected queue to a computation/processing circuit 12.

This allows for allocation of computation/processing in consideration of the processing details and the priority level of each piece of data, in addition to priority control in a communication network. It is therefore possible to execute the computation/processing in order from the highest-priority packet and to reduce the packet processing time. Thus, priority control in a communication network and allocation control of computation/processing on packets can be combined, and as a result, the computation/processing can be efficiently executed on the packets.

### Second Embodiment

Next, a network interface card 10 according to a second embodiment of the present invention will be described.

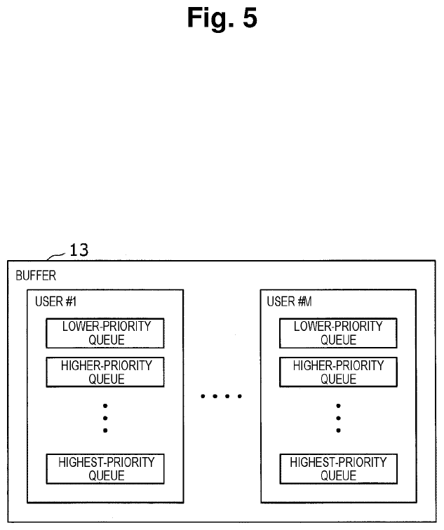

While the first embodiment shows an example in which the buffer 14 includes a queue for each priority level without distinction between users as illustrated in FIG. 2 described above, the present embodiment is different in that a buffer 14 includes a queue for each priority level for each user. FIG. 5 is a block diagram illustrating a configuration of a buffer according to the second embodiment.

That is, as illustrated in FIG. 5, the present embodiment provides a configuration in which the buffer 14 is provided with queues with different priority levels for each packet user, which is one of the packet classifications, a packet processing circuit 13 stores an input packet in the corresponding queue, and a control circuit 15 reads the packet from the corresponding queue on the basis of the packet priority level for each user and allocates the packet to a computation/processing circuit 12. At this time, it is also possible to set different thresholds of the accumulation time for each user by providing, for each user, a timer for measuring the accumulation time of a packet in the buffer 14.

This makes it possible to control allocation of packets to the computation/processing circuits 12 with finer granularity than in the first embodiment. Thus, for example, it is possible to shorten the processing time by preferentially performing reading from the queue for a user who uses a service with a strict restriction on the processing time. Furthermore, it is possible to homogenize service quality by performing allocation to the computation/processing circuits 12 so as to ensure fairness among the users.

### Operation of Second Embodiment

Next, an operation of the network interface card 10 according to the second embodiment will be described. The overall packet computation operation of the network interface card 10 is similar to that in FIG. 3 described above, and description thereof is omitted here.

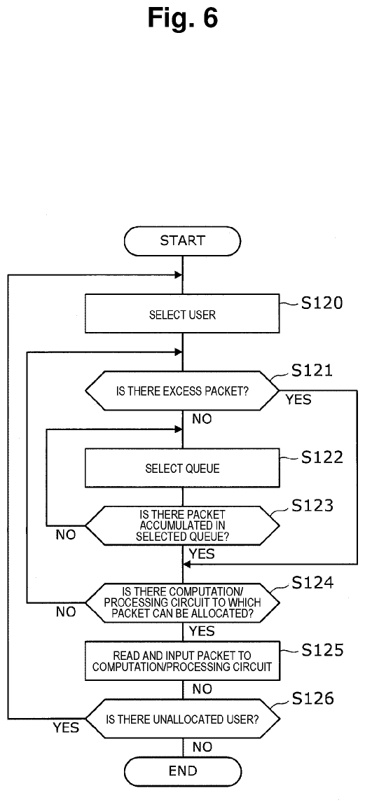

Packet control processing of the control circuit 15 in steps S103 and S104 in FIG. 3 in the packet computation operation according to the present embodiment will be described below with reference to FIG. 6. FIG. 6 is a flowchart illustrating the packet control processing of the control circuit according to the second embodiment.

In the present embodiment, the control circuit 15 as a whole reads a packet from the buffer 14 constituted by a queue for each priority level for each user on the basis of header information of the packet and outputs the packet to any of the computation/processing circuits 12. Hereinafter, with reference to FIG. 6, a case where packets of users are equally allocated to the computation/processing circuits 12 so as to ensure fairness among the users will be described as an example.

Specifically, first, the control circuit 15 selects a target user from available choices for the packet classification specified in advance (step S120) and checks whether there is an excess packet, which has an accumulation time that exceeds the threshold, among the packets accumulated in the queue of the user in the buffer 14 (step S121). In a case where there is an excess packet (step S121: YES), the processing proceeds to step S124 described later.

In a case where there is no excess packet (step S121: NO), the control circuit 15 selects, from the queues in the buffer 14, a queue from which a packet is to be read (step S122). For example, in a case where a queue is provided for each priority level for the user, the queues are selected in order from the highest-priority queue to a lower-priority queue.

Next, the control circuit 15 checks whether there is a packet accumulated in the selected queue (step S123). In a case where there is no packet accumulated in the selected queue (step S123: NO), the processing returns to step S122 to change the queue to be selected as a read queue. For example, in a case of selection in order from the highest-priority queue to a lower-priority queue, if no packet is accumulated in the highest-priority queue, a queue with the next highest priority (higher-priority queue) is selected as a read queue. In a case where there is a packet accumulated in the selected read queue (step S123: YES), the processing proceeds to step S124 described later.

In step S124, the control circuit 15 checks whether there is a computation/processing circuit 12 to which the packet to be read from the read queue can be allocated (step S124).

In a case where none of the computation/processing circuits 12 allows for allocation (step S124: NO), the control circuit 15 continues to accumulate the packet in the buffer 14 until the next allocation timing, and the processing returns to step S121. This applies to, for example, a case where the computation/processing circuit 12 capable of processing the packet is being used for processing another packet.

On the other hand, in a case where there is a computation/processing circuit 12 to which the packet can be allocated (step S124: YES), the packet is read from the selected read queue in the buffer 14 and input to the computation/processing circuit 12 (step S125).

Note that the control circuit 15 may grasp processing details to be executed by the computation/processing circuit 12 for the packet on the basis of the header information of the packet. In a case where a plurality of computation/processing circuits 12 that implement different functions is provided, a computation/processing circuit 12 capable of processing the packet at high speed or low power, that is, the computation/processing circuit 12 suitable for the details of the computation/processing, may be selected from the plurality of computation/processing circuits 12. For example, for processing with a relatively small amount of computation, a computation/processing circuit 12 such as a CPU or a general-purpose processor is selected. On the other hand, for processing with a relatively large amount of computation, such as detecting a person from a moving image, a computation/processing circuit 12 equipped with a GPU or hardware specialized for that processing is selected.

Thereafter, the control circuit 15 checks whether there is an unallocated user who has not been allocated to any of the computation/processing circuits 12 (step S126). In a case where there is an unallocated user (step S126: YES), the processing returns to step S120, a user is selected again, and similar processing is repeated. At this time, it is possible to ensure fairness among the users by not selecting the user who has been allocated once, but selecting another user. In a case where there is no unallocated user (step S126: NO), the series of packet control processing ends.

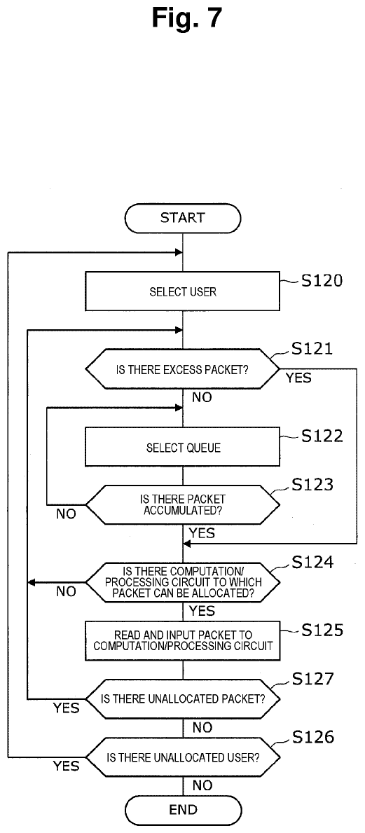

Next, another series of packet control processing of the control circuit 15 according to the present embodiment will be described with reference to FIG. 7. FIG. 7 is a flowchart illustrating the other series of packet control processing of the control circuit according to the second embodiment.

Hereinafter, a case where packets of the same user are allocated as many as possible, that is, a case where a user ID is allocated when a series of processing requests is made, in which computation/processing is allocated to packets in preferential order from a user with the processing request that has been made the earliest will be described with reference to FIG. 7.

In FIG. 7, steps S120 to S125 are the same as those in FIG. 6 described above.

After step S125, the control circuit 15 checks whether there is an unallocated packet in the buffer 14, such as a packet that can be allocated to another computation/processing circuit 12 (step S127). In a case where there is an unallocated packet (step S127: YES), the processing returns to step S121, and similar processing is repeated.

In a case where there is no unallocated packet (step S127: NO), the control circuit 15 checks whether there is an unallocated user who has not been allocated to any of the computation/processing circuits 12, as in FIG. 6 (step S126). In a case where there is an unallocated user (step S126: YES), the processing returns to step S120, a user is selected again, and similar processing is repeated. At this time, it is possible to ensure fairness among the users by not selecting the user who has been allocated once, but selecting another user. In a case where there is no unallocated user (step S126: NO), the series of packet control processing ends.

In the above description, users may be selected by a method in which the users are sequentially selected in ascending order of the user IDs for identifying the users, and a smaller user ID is given priority in this method. Thus, by cyclically allocating, such as in a round-robin manner, a user ID, which is allocated when a series of processing requests is made, it is possible to allocate computation/processing in a first-in first-out (FIFO) manner on the basis of the time when the user processing request has been made.

### Effects of Second Embodiment

As described above, the network interface card 10 of the present embodiment has a configuration in which the buffer 14 is provided with queues with different priority levels for each packet user, which is one of the packet classifications, the packet processing circuit 13 stores an input packet in the corresponding queue, and the control circuit 15 reads the packet from the corresponding queue on the basis of the packet priority level for each user and allocates the packet to a computation/processing circuit 12.

This allows a packet to be allocated to a computation/processing circuit 12 on the basis of the packet priority level for each user. Furthermore, it is also possible to set different thresholds of the accumulation time for each user by providing, for each user, a timer for measuring the time from the start of accumulation in a queue of the buffer 14. It is therefore possible to control allocation of packets to the computation/processing circuits 12 with finer granularity than in the first embodiment. Thus, for example, it is possible to perform parallel processing and shorten the processing time by preferentially performing reading from the queue for a user who uses a service with a strict restriction on the processing time. Furthermore, it is possible to homogenize service quality by performing allocation to the computation/processing circuits 12 so as to ensure fairness among the users.

### Third Embodiment

Next, a network interface card 10 according to a third embodiment of the present invention will be described.

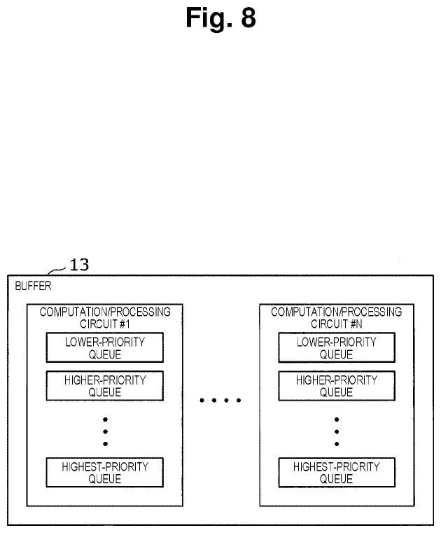

The first embodiment shows an example in which packets are accumulated in a queue for each priority level in the buffer 14 without distinction between users, and the second embodiment shows an example in which the buffer 14 includes a queue for each priority level for each user. The present embodiment is different in that a buffer 14 includes a queue for each priority level for each computation/processing circuit. FIG. 8 is a block diagram illustrating a configuration of a buffer according to the third embodiment.

That is, as illustrated in FIG. 8, the present embodiment provides a configuration in which the buffer 14 is provided with queues with different priority levels for each computation/processing circuit 12, which is one of the packet classifications, a packet processing circuit 13 stores an input packet in the corresponding queue, and a control circuit 15 reads the packet from the corresponding queue on the basis of the packet priority level for each computation/processing circuit 12 and allocates the packet to the computation/processing circuit 12.

As a result, in a case where the computation/processing circuits 12 are different in processing details, it is possible to control the order of processing among the computation/processing circuits 12. In a case where the computation/processing circuits 12 are the same in processing details, when packets are input, the packets are stored in the queues in the buffer 14 so that the computation/processing circuits 12 become equal in the number of packets accumulated, and thus it is possible to avoid the load from being concentrated on a specific computation/processing circuit 12 and to homogenize the processing load.

### Operation of Third Embodiment

Next, an operation of the network interface card 10 according to the third embodiment will be described. The overall packet computation operation of the network interface card 10 is similar to that in FIG. 3 described above, and description thereof is omitted here.

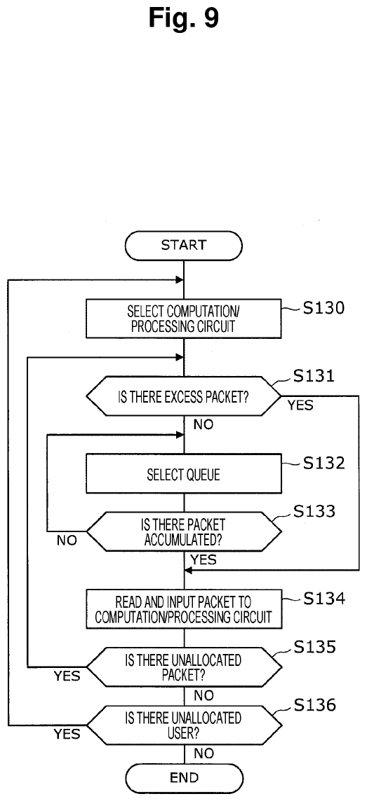

Packet control processing of the control circuit 15 in steps S103 and S104 in FIG. 3 in the packet computation operation according to the present embodiment will be described below with reference to FIG. 9. FIG. 9 is a flowchart illustrating the packet control processing of the control circuit according to the third embodiment.

In the present embodiment, the control circuit 15 as a whole reads a packet from the buffer 14 constituted by a queue for each priority level for each computation/processing circuit on the basis of header information of the packet and outputs the packet to any of the computation/processing circuits 12.

Specifically, first, the control circuit 15 selects a computation/processing circuit 12 to which a packet can be allocated from among the computation/processing circuits 12 on the basis of available choices for the packet classification specified in advance (step S130) and checks whether there is an excess packet, which has an accumulation time that exceeds the threshold, among the packets accumulated in the queue of the computation/processing circuit 12 in the buffer 14 (step S131). In a case where there is an excess packet (step S131: YES), the processing proceeds to step S134 described later.

In a case where there is no excess packet (step S131: NO), the control circuit 15 selects, from the queues in the buffer 14, a queue from which a packet is to be read (step S132). For example, in a case where a queue is provided for each priority level for the computation/processing circuit 12, the queues are selected in order from the highest-priority queue to a lower-priority queue.

Next, the control circuit 15 checks whether there is a packet accumulated in the selected queue (step S133). In a case where there is no packet accumulated in the selected queue (step S133: NO), the processing returns to step S132 to change the queue to be selected as a read queue. For example, in a case of selection in order from the highest-priority queue to a lower-priority queue, if no packet is accumulated in the highest-priority queue, a queue with the next highest priority (higher-priority queue) is selected as a read queue. In a case where there is a packet accumulated in the selected read queue (step S133: YES), the processing proceeds to step S134 described later.

In step S134, the control circuit 15 reads the packet from the selected read queue in the buffer 14 and inputs the packet to the computation/processing circuit 12 (step S134).

Note that the control circuit 15 may grasp processing details to be executed by the computation/processing circuit 12 for the packet on the basis of the header information of the packet. In a case where a plurality of computation/processing circuits 12 that implement different functions is provided, a computation/processing circuit 12 capable of processing the packet at high speed or low power, that is, the computation/processing circuit 12 suitable for the details of the computation/processing, may be selected from the plurality of computation/processing circuits 12. For example, for processing with a relatively small amount of computation, a computation/processing circuit 12 such as a CPU or a general-purpose processor is selected. On the other hand, for processing with a relatively large amount of computation, such as detecting a person from a moving image, a computation/processing circuit 12 equipped with a GPU or hardware specialized for that processing is selected.

Thereafter, the control circuit 15 checks whether there is an unallocated packet that has not been allocated to any of the computation/processing circuits 12 in the selected read queue (step S135). In a case where there is an unallocated packet (step S135: YES), the processing returns to step S131, and similar processing is repeated.

In a case where there is no unallocated packet (step S135: NO), the control circuit 15 checks whether there is an unallocated computation/processing circuit 12 to which no packet has been allocated (step S136). In a case where there is an unallocated computation/processing circuit 12 (step S136: YES), the processing returns to step S130, a computation/processing circuit 12 is selected, and similar processing is repeated. In a case where there is no unallocated computation/processing circuit 12 (step S136: NO), the series of packet control processing ends.

### Effects of Third Embodiment

As described above, the network interface card 10 of the present embodiment has a configuration in which the buffer 14 is provided with queues with different priority levels for each computation/processing circuit 12, which is one of the packet classifications, the packet processing circuit 13 stores an input packet in the corresponding queue, and the control circuit 15 reads the packet from the corresponding queue on the basis of the packet priority level for each computation/processing circuit 12 and allocates the packet to the computation/processing circuit 12.

This allows a packet to be allocated to a computation/processing circuit 12 on the basis of the packet priority level for each computation/processing circuit 12. It is therefore possible to control allocation of packets to the computation/processing circuits 12 with finer granularity than in the first embodiment. Thus, for example, in a case where the computation/processing circuits 12 are different in processing details, it is possible to control the order of processing among the computation/processing circuits 12. In a case where the computation/processing circuits 12 are the same in processing details, when packets are input, the packets are stored in the queues so that the computation/processing circuits 12 become equal in the number of packets accumulated, and thus it is possible to homogenize the processing load without the load being concentrated only on a specific computation/processing circuit 12.

### Fourth Embodiment

Next, a network interface card 10 according to a fourth embodiment of the present invention will be described.

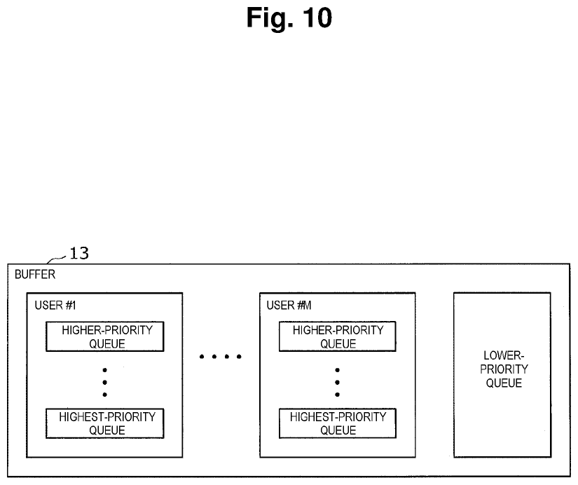

The second embodiment shows an example in which the buffer 14 includes a queue for each priority level for each user. The present embodiment is different in that a buffer 14 includes a common queue that does not distinguish between users, in addition to a queue for each priority level for each user. FIG. 10 is a block diagram illustrating a configuration of a buffer according to the fourth embodiment.

That is, as illustrated in FIG. 10, the present embodiment provides a configuration in which the buffer 14 is provided with queues with different priority levels for each packet user, which is one of the packet classifications, and is also provided with a lower-priority queue that does not distinguish between users, that is, common to the users, a packet processing circuit 13 stores an input packet in the corresponding queue, and a control circuit 15 reads the packet from the corresponding queue and allocates the packet to a computation/processing circuit 12 on the basis of the packet priority level for each user, and, for a lower-priority packet, reads the packet from the lower-priority queue common to the users and allocates the packet to a computation/processing circuit 12.

This makes it possible to control allocation of packets to the computation/processing circuits 12 with fine granularity equivalent to that in the second and third embodiments described above. Furthermore, sharing the lower-priority queue allows for a reduction in accumulation capacity of the buffer 14.

### Operation of Fourth Embodiment

Next, an operation of the network interface card 10 according to the fourth embodiment will be described. The overall packet computation operation of the network interface card 10 is similar to that in FIG. 3 described above, and description thereof is omitted here.

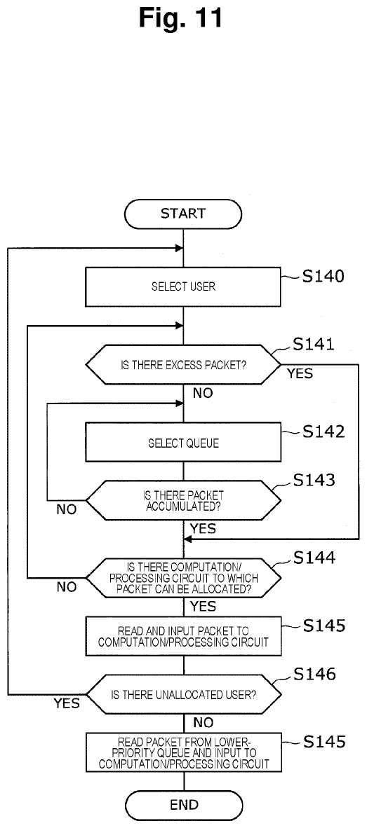

Packet control processing of the control circuit 15 in steps S103 and S104 in FIG. 3 in the packet computation operation according to the present embodiment will be described below with reference to FIG. 11. FIG. 11 is a flowchart illustrating the packet control processing of the control circuit according to the fourth embodiment.

In the present embodiment, the control circuit 15 as a whole reads a packet from the buffer 14 constituted by a queue for each priority level for each user and the lower-priority queue common to users on the basis of header information of the packet and outputs the packet to any of the computation/processing circuits 12.

Specifically, first, the control circuit 15 selects a target user from available choices for the packet classification specified in advance (step S140) and checks whether there is an excess packet, which has an accumulation time that exceeds the threshold, among the packets accumulated in the queue of the user in the buffer 14 (step S141). In a case where there is an excess packet (step S141: YES), the processing proceeds to step S144 described later.

In a case where there is no excess packet (step S141: NO), the control circuit 15 selects, from the queues in the buffer 14, a queue from which a packet is to be read (step S142). For example, in a case where a queue is provided for each priority level for the user, the queues are selected in order from the highest-priority queue to a lower-priority queue.

Next, the control circuit 15 checks whether there is a packet accumulated in the selected queue (step S143). In a case where there is no packet accumulated in the selected queue (step S143: NO), the processing returns to step S142 to change the queue to be selected as a read queue. For example, in a case of selection in order from the highest-priority queue to a lower-priority queue, if no packet is accumulated in the highest-priority queue, a queue with the next highest priority (higher-priority queue) is selected as a read queue. In a case where there is a packet accumulated in the selected read queue (step S143: YES), the processing proceeds to step S144 described later.

In step S144, the control circuit 15 checks whether there is a computation/processing circuit 12 to which the packet to be read from the read queue can be allocated (step S144).

In a case where none of the computation/processing circuits 12 allows for allocation (step S144: NO), the control circuit 15 continues to accumulate the packet in the buffer 14 until the next allocation timing, and the processing returns to step S141. This applies to, for example, a case where the computation/processing circuit 12 capable of processing the packet is being used for processing another packet.

On the other hand, in a case where there is a computation/processing circuit 12 to which the packet can be allocated (step S144: YES), the packet is read from the selected read queue in the buffer 14 and input to the computation/processing circuit 12 (step S145).

Note that the control circuit 15 may grasp processing details to be executed by the computation/processing circuit 12 for the packet on the basis of the header information of the packet. In a case where a plurality of computation/processing circuits 12 that implement different functions is provided, a computation/processing circuit 12 capable of processing the packet at high speed or low power, that is, the computation/processing circuit 12 suitable for the details of the computation/processing, may be selected from the plurality of computation/processing circuits 12. For example, for processing with a relatively small amount of computation, a computation/processing circuit 12 such as a CPU or a general-purpose processor is selected. On the other hand, for processing with a relatively large amount of computation, such as detecting a person from a moving image, a computation/processing circuit 12 equipped with a GPU or hardware specialized for that processing is selected.

Thereafter, the control circuit 15 checks whether there is an unallocated user who has not been allocated to any of the computation/processing circuits 12 (step S146). In a case where there is an unallocated user (step S146: YES), the processing returns to step S140, a user is selected again, and similar processing is repeated. At this time, it is possible to ensure fairness among the users by not selecting the user who has been allocated once, but selecting another user.

In a case where there is no unallocated user (step S146: NO), the control circuit 15 sequentially reads all the packets that can be allocated to the computation/processing circuits 12 from the lower-priority queue common to the users in the buffer 14, allocates the packets to the computation/processing circuits 12 (step S147), and then ends the series of packet control processing.

### Effects of Fourth Embodiment

As described above, the network interface card 10 of the present embodiment has a configuration in which the buffer 14 is provided with queues with different priority levels for each packet user, which is one of the packet classifications, and is also provided with a lower-priority queue that does not distinguish between users, that is, common to the users, the packet processing circuit 13 stores an input packet in the corresponding queue, and the control circuit 15 reads the packet from the corresponding queue and allocates the packet to a computation/processing circuit 12 on the basis of the packet priority level for each user, and, for a lower-priority packet, reads the packet from the lower-priority queue common to the users and allocates the packet to a computation/processing circuit 12.

As a result, lower-priority packets can be allocated to the computation/processing circuits 12 without distinction between users. It is therefore possible to control allocation of packets to the computation/processing circuits 12 with fine granularity equivalent to that in the second embodiment. Furthermore, sharing the lower-priority queue allows for a reduction in accumulation capacity of the buffer 14.

### Fifth Embodiment

First, a network interface card 10 according to a fifth embodiment of the present invention will be described.

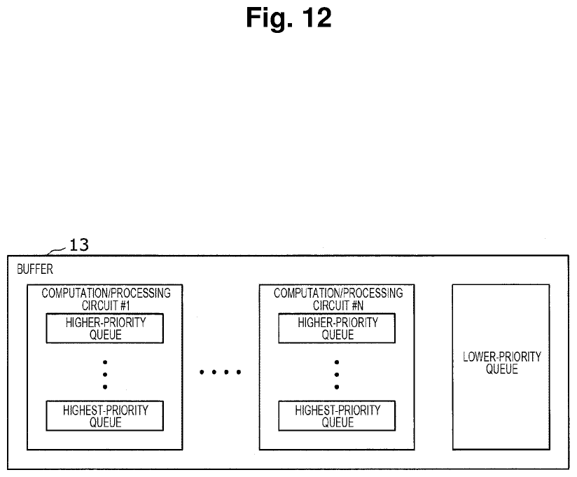

The fourth embodiment shows an example in which the buffer 14 includes a lower-priority queue that does not distinguish between users, in addition to a queue for each priority level for each user. The present embodiment is different in that a buffer 14 includes a lower-priority queue that does not distinguish between computation/processing circuits 12, in addition to a queue for each priority level for each computation/processing circuit. FIG. 12 is a block diagram illustrating a configuration of a buffer according to the fifth embodiment.

That is, as illustrated in FIG. 10, the present embodiment provides a configuration in which the buffer 14 is provided with queues with different priority levels for each computation/processing circuit 12, which is one of the packet classifications, and is also provided with a lower-priority queue that does not distinguish between the computation/processing circuits 12, that is, common to the computation/processing circuits 12, a packet processing circuit 13 stores an input packet in the corresponding queue, and a control circuit 15 reads the packet from the corresponding queue and allocates the packet to a computation/processing circuit 12 on the basis of the packet priority level for each computation/processing circuit 12, and, for a lower-priority packet, reads the packet from the lower-priority queue common to the computation/processing circuits 12 and allocates the packet to a computation/processing circuit 12.

As a result, in a case where the computation/processing circuits 12 are different in processing details, it is possible to control the order of processing among the computation/processing circuits 12. In a case where the computation/processing circuits 12 are the same in processing details, when packets are input, the packets are stored in the queues in the buffer 14 so that the computation/processing circuits 12 become equal in the number of packets accumulated, and thus it is possible to avoid the load from being concentrated on a specific computation/processing circuit 12 and to homogenize the processing load. Furthermore, it is possible to control allocation of packets to the computation/processing circuits 12 with fine granularity equivalent to that in the third embodiment described above. Furthermore, sharing the lower-priority queue allows for a reduction in accumulation capacity of the buffer 14.

### Operation of Fifth Embodiment

Next, an operation of the network interface card 10 according to the fifth embodiment will be described. The overall packet computation operation of the network interface card 10 is similar to that in FIG. 3 described above, and description thereof is omitted here.

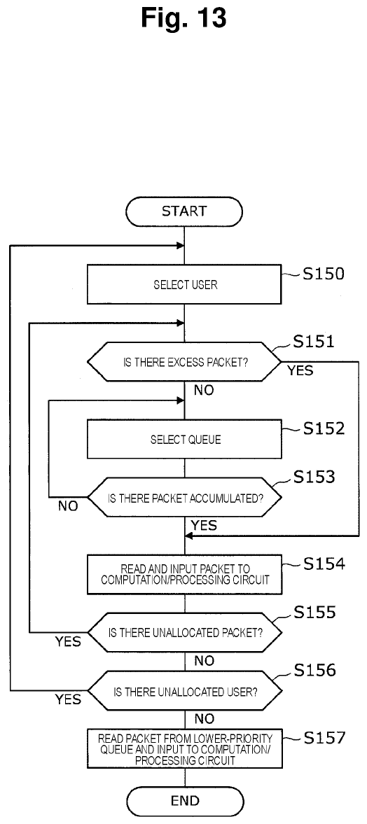

Packet control processing of the control circuit 15 in steps S103 and S104 in FIG. 3 in the packet computation operation according to the present embodiment will be described below with reference to FIG. 13. FIG. 13 is a flowchart illustrating the packet control processing of the control circuit according to the fifth embodiment.

In the present embodiment, the control circuit 15 as a whole reads a packet from the buffer 14 constituted by a queue for each priority level for each computation/processing circuit and the lower-priority queue common to the computation/processing circuits 12 on the basis of header information of the packet and outputs the packet to any of the computation/processing circuits 12.

Specifically, first, the control circuit 15 selects a computation/processing circuit 12 to which a packet can be allocated from among the computation/processing circuits 12 on the basis of available choices for the packet classification specified in advance (step S150) and checks whether there is an excess packet, which has an accumulation time that exceeds the threshold, among the packets accumulated in the queue of the computation/processing circuit 12 in the buffer 14 (step S151). In a case where there is an excess packet (step S151: YES), the processing proceeds to step S154 described later.

In a case where there is no excess packet (step S151: NO), the control circuit 15 selects, from the queues in the buffer 14, a queue from which a packet is to be read (step S152). For example, in a case where a queue is provided for each priority level for the computation/processing circuit 12, the queues are selected in order from the highest-priority queue to a lower-priority queue.

Next, the control circuit 15 checks whether there is a packet accumulated in the selected queue (step S153). In a case where there is no packet accumulated in the selected queue (step S153: NO), the processing returns to step S152 to change the queue to be selected as a read queue. For example, in a case of selection in order from the highest-priority queue to a lower-priority queue, if no packet is accumulated in the highest-priority queue, a queue with the next highest priority (higher-priority queue) is selected as a read queue. In a case where there is a packet accumulated in the selected read queue (step S153: YES), the processing proceeds to step S154 described later.

In step S154, the control circuit 15 reads the packet from the selected read queue in the buffer 14 and inputs the packet to the computation/processing circuit 12 (step S154).

Note that the control circuit 15 may grasp processing details to be executed by the computation/processing circuit 12 for the packet on the basis of the header information of the packet. In a case where a plurality of computation/processing circuits 12 that implement different functions is provided, a computation/processing circuit 12 capable of processing the packet at high speed or low power, that is, the computation/processing circuit 12 suitable for the details of the computation/processing, may be selected from the plurality of computation/processing circuits 12. For example, for processing with a relatively small amount of computation, a computation/processing circuit 12 such as a CPU or a general-purpose processor is selected. On the other hand, for processing with a relatively large amount of computation, such as detecting a person from a moving image, a computation/processing circuit 12 equipped with a GPU or hardware specialized for that processing is selected.

Thereafter, the control circuit 15 checks whether there is an unallocated packet that has not been allocated to any of the computation/processing circuits 12 in the selected read queue (step S155). In a case where there is an unallocated packet (step S155: YES), the processing returns to step S151, and similar processing is repeated.

In a case where there is no unallocated packet (step S155: NO), the control circuit 15 checks whether there is an unallocated computation/processing circuit 12 to which no packet has been allocated (step S156). In a case where there is an unallocated computation/processing circuit 12 (step S156: YES), the processing returns to step S150, a computation/processing circuit 12 is selected again, and similar processing is repeated.

In a case where there is no unallocated computation/processing circuit 12 (step S156: NO), the control circuit 15 sequentially reads all the packets that can be allocated to the computation/processing circuits 12 from the lower-priority queue common to the computation/processing circuits 12 in the buffer 14, allocates the packets to the computation/processing circuits 12 (step S157), and then ends the series of packet control processing.

### Effects of Fifth Embodiment

As described above, the network interface card 10 of the present embodiment has a configuration in which the buffer 14 is provided with queues with different priority levels for each computation/processing circuit 12, which is one of the packet classifications, and is also provided with a lower-priority queue that does not distinguish between the computation/processing circuits 12, that is, common to the computation/processing circuits 12, the packet processing circuit 13 stores an input packet in the corresponding queue, and the control circuit 15 reads the packet from the corresponding queue and allocates the packet to a computation/processing circuit 12 on the basis of the packet priority level for each computation/processing circuit 12, and, for a lower-priority packet, reads the packet from the lower-priority queue common to the computation/processing circuits 12 and allocates the packet to a computation/processing circuit 12.

As a result, lower-priority packets can be allocated to the computation/processing circuits 12 without distinction between the computation/processing circuits 12. It is therefore possible to control allocation of packets to the computation/processing circuits 12 with fine granularity equivalent to that in the third embodiment. Furthermore, sharing the lower-priority queue allows for a reduction in accumulation capacity of the buffer 14.

### Sixth Embodiment

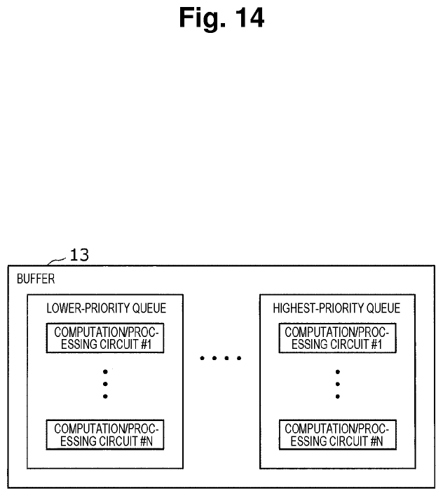

Next, a network interface card 10 according to a sixth embodiment of the present invention will be described with reference to FIG. 14. FIG. 14 is a block diagram illustrating a configuration of a buffer according to the sixth embodiment.

The difference from other embodiments is that a buffer 14 includes a queue for each priority level for each computation/processing circuit. In the present embodiment, a packet is stored in a queue for each packet priority level for each computation/processing circuit and is allocated to a computation/processing circuit 12. As a result, operations and effects similar to those of the third embodiment can be obtained.

### Seventh Embodiment

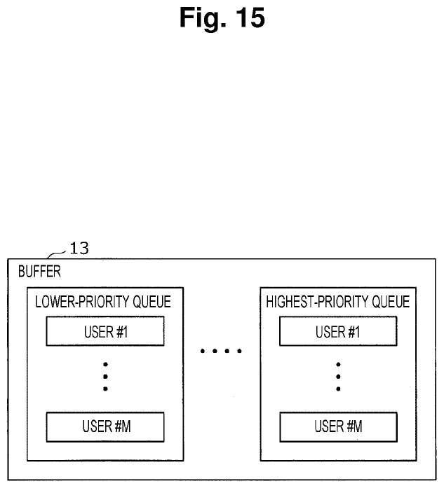

Next, a network interface card 10 according to a seventh embodiment of the present invention will be described with reference to FIG. 15. FIG. 15 is a block diagram illustrating a configuration of a buffer according to the seventh embodiment.

The difference from other embodiments is that a buffer 14 includes a queue for each priority level and for each user. In the present embodiment, a packet is stored in a queue for each packet priority level for each user and is allocated to a computation/processing circuit 12. As a result, operations and effects similar to those of the second embodiment can be obtained.

### Eighth Embodiment

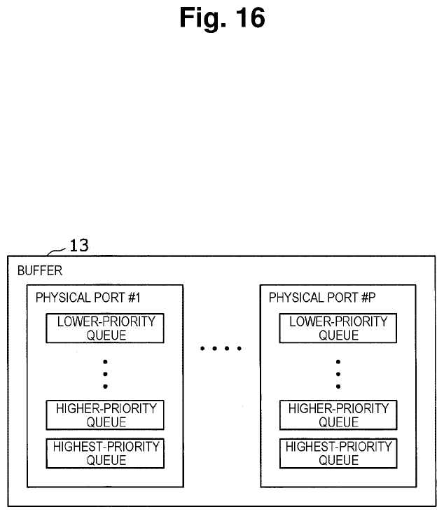

Next, a network interface card 10 according to an eighth embodiment of the present invention will be described with reference to FIG. 16. FIG. 16 is a block diagram illustrating a configuration of a buffer according to the eighth embodiment.

The difference from other embodiments is that a buffer 14 includes a queue for each priority level for each physical port. In the present embodiment, a packet is stored in a queue for each priority level on the basis of the packet priority level for each physical port to which packets are input and is allocated to a computation/processing circuit 12. This allows for priority control for each physical port and makes it possible to reduce the time for processing packets accumulated in the highest-priority queue among the physical ports 11 while preferentially handling a packet input from a specific physical port 11.

### Ninth Embodiment

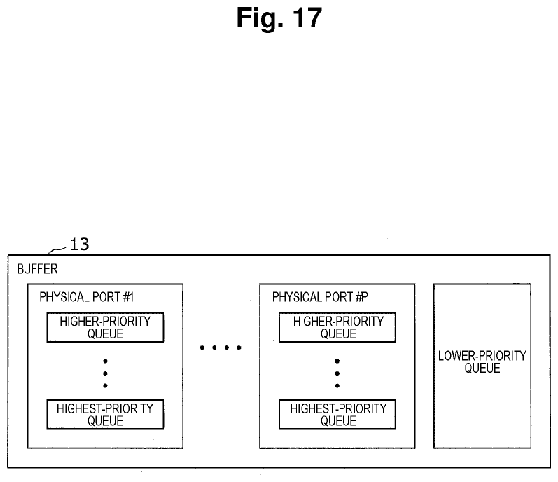

Next, a network interface card 10 according to a ninth embodiment of the present invention will be described with reference to FIG. 17. FIG. 17 is a block diagram illustrating a configuration of a buffer according to the ninth embodiment.

The difference from other embodiments is that a buffer 14 includes a lower-priority queue that does not distinguish between physical ports 11 and is shared between the physical ports 11, in addition to a queue for each priority level for each physical port. In the present embodiment, a packet is stored in a queue and allocated to a computation/processing circuit 12 on the basis of the packet priority level for each physical port 11, the lower-priority queue performs accumulation with the use of a queue that collectively accumulates a plurality of the physical ports 11, that is, a queue shared between the physical ports 11, and lower-priority packets are allocated to the computation/processing circuits 12 without distinction between the physical ports 11. This makes it possible to control allocation of packets to the computation/processing circuits 12 with fine granularity equivalent to that in the eighth embodiment. Furthermore, sharing the lower-priority queue allows for a reduction in accumulation capacity of the buffer 14.

### Tenth Embodiment

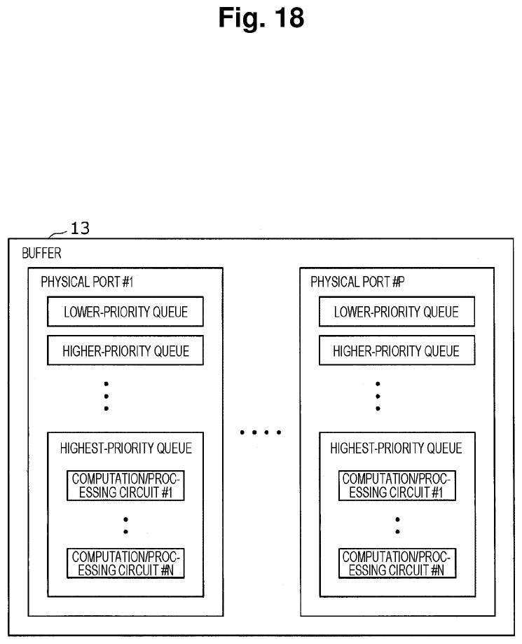

Next, a network interface card 10 according to a tenth embodiment of the present invention will be described with reference to FIG. 18. FIG. 18 is a block diagram illustrating a configuration of a buffer according to the tenth embodiment.

The difference from other embodiments is that a buffer 14 includes a queue for each piece of computation/processing for each priority level for each physical port. In the present embodiment, packets are sorted on the basis of the packet priority levels for each physical port 11, and the packets are stored in the queues for each computation/processing circuit and allocated to computation/processing circuits 12. As a result, more detailed control can be performed than in other embodiments.

### Eleventh Embodiment

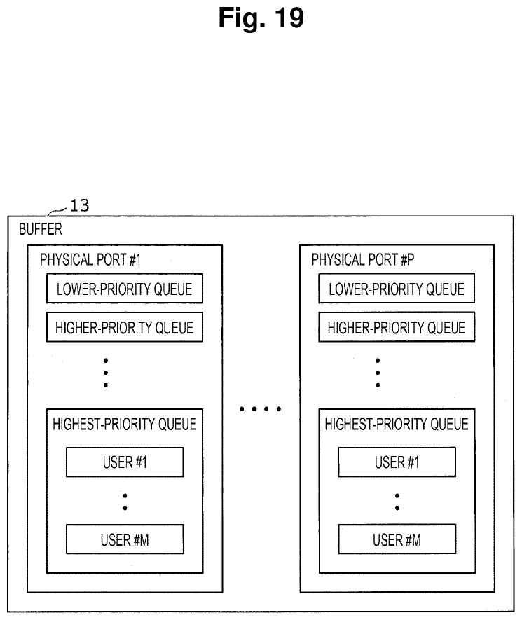

Next, a network interface card 10 according to an eleventh embodiment of the present invention will be described with reference to FIG. 19. FIG. 19 is a block diagram illustrating a configuration of a buffer according to the eleventh embodiment.

The difference from other embodiments is that a buffer 14 includes a queue for each user for each priority level for each physical port. In the present embodiment, packets are sorted on the basis of the packet priority levels for each physical port, and the packets are stored in a queue for each user and allocated to computation/processing circuits. As a result, more detailed control can be performed than in other embodiments.

### Extension of Embodiments

Embodiments of the present invention have been described by referring to exemplary embodiments but are not limited to the above embodiments. Various changes understandable by those skilled in the art can be made for the configurations and details of embodiments of the present invention within the scope of the present invention. In addition, each embodiment can be implemented in any combination within a consistent range.

### REFERENCE SIGNS LIST

10 Network interface card
11 Physical port
12 Computation/processing circuit
13 Packet processing circuit
14 Buffer
15 Control circuit
L Transmission path.

1.-5. (canceled)

6. A network interface card comprising:
a plurality of physical ports configured to receive and transmit first packets via transmission paths;
a buffer configured to temporarily accumulate the first packets, the buffer comprising a plurality of queues corresponding to priority levels of the first packets;
a packet processing circuit configured to store, in the buffer, the first packets received by the plurality of physical ports, wherein the first packets are stored in respective ones of the queues in the buffer based on the priority levels of the first packets;
a plurality of computation/processing circuits configured to perform predetermined computation/processing on second packets read from the buffer; and
a control circuit configured to control reading from the buffer and allocation of the second packets to the computation/processing circuits, wherein the control circuit is configured to sequentially select the queues in the buffer based on the priority levels of the first packets and to allocate the second packets read from the selected queues to the plurality of computation/processing circuits.

7. The network interface card according to claim 6, wherein:
each of the queues corresponds to a combination of the priority level and a packet classification of each of the first packets, wherein the packet classification indicates a classification to which the first packet belongs and is based on a packet user, the computation/processing circuit configured to perform computation/processing on the second packet, or the physical port that has received the first packet;
the packet processing circuit is configured to analyze the priority level and the packet classification obtained from each of the first packets and to store each of the first packets in a respective queue of the queues in the buffer that corresponds to the priority level and the packet classification; and
the control circuit is configured to sequentially select the queues in the buffer based on the combination of the priority level and the packet classification and to read the second packets from the selected queues.

8. The network interface card according to claim 7, wherein the control circuit is configured to read the second packets in which a packet accumulation time exceeds a preset threshold among the first packets accumulated in the selected queues.

9. The network interface card according to claim 7, wherein:
the buffer further comprises a common queue having a specific priority level and common to each of the packet classifications; and
the control circuit is configured to sequentially select the queues in the buffer based on the combination of the priority level and the packet classification or to select the common queue based on the priority level and read the second packets from the selected queues.

10. The network interface card according to claim 6, wherein the control circuit is configured to read the second packets in which a packet accumulation time exceeds a preset threshold among the first packets accumulated in the selected queues.

11. A packet processing method used in a network interface card, the network interface card comprising a plurality of physical ports that receive and transmit first packets via transmission paths, a buffer that temporarily accumulates the first packets, a packet processing circuit that stores, in the buffer, the first packets received by the plurality of physical ports, a plurality of computation/processing circuits that perform predetermined computation/processing on second packets read from the buffer, and a control circuit that controls reading from the buffer and allocation of the second packets to the computation/processing circuits, the packet processing method comprising:
storing, by the packet processing circuit, the first packets in queues in the buffer, wherein the queues correspond to priority levels of the first packets; and
sequentially selecting, by the control circuit, the queues in the buffer based on the priority level and allocating the second packets read from the selected queues to the plurality of computation/processing circuits.

12. The packet processing method according to claim 11, wherein each of the queues corresponds to a combination of the priority level and a packet classification of each of the first packets, wherein the packet classification indicates a classification to which the first packet belongs and is based on a packet user, the computation/processing circuit capable of performing computation/processing on the second packet, or the physical port that received the first packet.

13. The packet processing method according to claim 12, further comprising:
analyzing, by the packet processing circuit, the priority level and the packet classification obtained from each of the first packets and storing each of the first packets in a respective queue of the queues in the buffer according to the priority level and the packet classification of each of the first packets; and
sequentially selecting, by the control circuit, the queues in the buffer based on the combination of the priority level and the packet classification and reading the second packets from the selected queues.

14. The packet processing method according to claim 13, wherein the control circuit is configured to read the second packets in which a packet accumulation time exceeds a preset threshold among the first packets accumulated in the selected queues.

15. The packet processing method according to claim 13, wherein the buffer further comprises a common queue having a specific priority level and common to each of the packet classifications, and wherein the method further comprises:
sequentially selecting, by the control circuit, the queues in the buffer based on the combination of the priority level and the packet classification or selecting the common queue based on the priority level; and
reading the second packets from the selected queues.

16. The packet processing method according to claim 11, further comprising reading, by the control circuit, the second packets in which a packet accumulation time exceeds a preset threshold among the first packets accumulated in the selected queues.
